(19) United States
(12) Patent Application Publication
(10) Pub. No.: US 2004/0102536 A1
(43) Pub. Date: May 27, 2004

(54) Cellular polyisocyanate polyaddition products

(76) Inventors: Heinz Bollmann, Alfhausen (DE); Hermann Dietrich Wagner, Gropella d'Adda (IT); Michael Strauss, Lemforde (DE); Torsten Jeschke, Wimmer (DE)

Correspondence Address: Basf Corporation, Patent Department, 1609 Biddle Avenue, Wyandotte, MI, 48192, US

(21) Appl. No.: 10/472,476

(22) PCT Filed: Mar. 28, 2002
(86) PCT No.: PCT/EP02/03501

(30) Foreign Application Priority Data
Apr. 6, 2001 (DE) 10117089.0

(51) Int. Cl. C08G 18/00

(52) U.S. Cl. 521/155

(57) ABSTRACT

Cellular polyisocyanate polyadducts are prepared by reacting (a) isocyanates with (b) compounds reactive toward isocyanates and (d) water, by a process in which a polyester having 2 hydroxyl groups and based on the condensation of at least one dicarboxylic acid with at least one alkanediol and/or alkenediol of 3 to 6 carbon atoms, whose carbon skeleton has at least one alkyl and/or alkenyl side chain between the hydroxyl groups, is used as (b).

The present invention relates to a process for the preparation of cellular polyisocyanate polyadducts, preferably polyurethane elastomers, particularly preferably microcellular polyurethane elastomers, which may contain isocyanurate and/or urea structures, by reacting (a) isocyanates with (b) compounds reactive toward isocyanates and (d) water. The present invention furthermore relates to cellular polyisocyanate polyadducts obtainable in this manner and to their use.

Cellular, for example microcellular, polyisocyanate polyadducts, usually polyurethanes and/or polyisocyanurates, which may contain urea structures and are obtainable by reacting isocyanates with compounds reactive toward isocyanates and processes for their preparation are generally known.

A particular development of these products comprises cellular, in particular microcellular, polyurethane elastomers which differ from conventional polyurethane foams through their substantially higher density of, usually, from 300 to 600 kg/m³, their particular physical properties and the consequent potential applications. Such polyurethane elastomers are used, for example, as vibration- and impact-damping elements, in particular in automotive construction. The suspension elements produced from polyurethane elastomers are pushed onto the piston rod of the shock absorber in automobiles, for example inside the total shock-absorbing leg construction, consisting of shock absorber, coil spring and the elastomer spring.

During use, components of microcellular polyurethane elastomers are sometimes exposed to elevated temperatures in combination with moisture and the influence of microbes. For this reason, very good hydrolysis resistance of the materials is desirable so that they can meet the high mechanical demands made upon them over a very long period. Temperatures below the glass transition temperature of the cellular polyurethane elastomer lead to loss of the elastic properties of the component. For specific applications, it is therefore desirable further to improve the low-temperature flexibility of the cellular polyurethane elastomers without adversely affecting the good static and dynamic properties of these materials.

Further requirements which the cellular polyisocyanate polyadducts have to meet include the achievement of excellent dynamic mechanical and static mechanical properties, for example excellent tensile strength, elongations, tear propagation strength and compression sets, so that in particular the polyurethane elastomers can meet the high mechanical requirements set for the damping elements over a very long period.

DE-A 36 13 650 and EP-A 178 562 describe the preparation of resilient, compact or cellular polyurethane elastomers. The polyetheresterdiols used as the polyol component and prepared from polyoxytetramethylene glycols having molecular weights of from 162 to 10 000 and organic dicarboxylic acids lead to improved hydrolysis stabilities of the polyurethane elastomers compared with the use of pure polyesterpolyols. However, a disadvantage is the high price of the novel polyetheresterpolyols. Neither of the two patents provide any information about the low-temperature flexibility of the polyurethane elastomers prepared according to the invention.

It is an object of the present invention to provide cellular polyisocyanate polyadducts, preferably cellular polyurethane elastomers, preferably those having a density of from 200 to 750, particularly preferably from 300 to 600, kg/m³, which have improved hydrolysis stability in combination with improved low-temperature flexibility and very good static and dynamic properties. Improved hydrolysis stability would at the same time permit the use of microbicides for improving the resistance to microbes. The cellular polyurethane elastomers should in particular be capable of being used as damping elements, for example in automotive construction.

We have found that this object is achieved if a polyester having 2 hydroxyl groups and based on the condensation of at least one dicarboxylic acid with an alkanediol and/or alkenediol, preferably an alkanediol of 3 to 6, preferably 4 or 5, particularly preferably 4, carbon atoms, whose carbon skeleton has at least one alkyl and/or alkenyl side chain between the hydroxyl groups, is used as (b).

A polyester having 2 hydroxyl groups and based on the condensation of at least one dicarboxylic acid with a mixture (i) containing from 0 to 90, preferably from 0 to 70, particularly preferably from 0 to 60,% by weight of butane-1,4-diol, pentane-1,5-diol and/or hexane-1,6-diol, preferably butane-1,4-diol, and from 10 to 100, preferably from 30 to 100, particularly preferably from 40 to 100, % by weight of an alkanediol and/or alkenediol, preferably an alkanediol of 3 to 6, preferably 4 or 5, particularly preferably 4, carbon atoms, whose carbon skeleton has at least one alkyl and/or alkenyl side chain between the hydroxyl groups, is particularly preferably used as (b), the stated weights being based on the total weight of the mixture (i).

Propane-1,2-diol, 2-methylpropane-1,3-diol, 2-methylpropane-1,2-diol, 2-methylbutane-1,4-diol, 2-methylbutane-1,3-diol, 2-methylbutane-1,2-diol, butane-1,2-diol, pentane-1,2-diol 3-methylpentane-1,5-diol, neopentylglycol and/or pentane-1,3-diol, particularly preferably 2-methylpropane-1,2-diol, 2-methylbutane-1,4-diol and/or 2-methylbutane-1,3-diol, in particular 2-methylpropane-1,3-diol, are preferred as the alkanediol whose carbon skeleton has at least one alkyl and/or alkenyl side chain between the hydroxyl groups.

The polyester having 2 hydroxyl groups can be prepared by generally known processes for condensation, usually at elevated temperatures and reduced pressure, in known apparatuses, preferably in the presence of conventional catalysts. For example, the organic dicarboxylic acids and/or derivatives thereof and polyhydric alcohols can be subjected to polycondensation in the absence of a catalyst or preferably in the presence of esterification catalysts, expediently in an atmosphere comprising inert gas, e.g. nitrogen, carbon monoxide, helium, argon, etc., in the melt at from 150 to 250° C., preferably from 180 to 220° C., under atmospheric or reduced pressure, up to the desired acid number, which is advantageously less than 10, preferably less than 2. According to a preferred embodiment, the esterification mixture is subjected to polycondensation at the abovementioned temperatures up to an acid number of from 80 to 30, preferably from 40 to 30, under atmospheric pressure and then under a pressure of less than 500, preferably from 50 to 150, mbar. Examples of suitable esterification catalysts are iron, cadmium, cobalt, lead, zinc, antimony, magnesium, titanium and tin catalysts in the form of metals, metal oxides or metal salts. However, the polycondensation can also be carried out in the liquid phase in the presence of diluents and/or entraining agents, e.g. benzene, toluene, xylene or chlorobenzene, for removing the condensation water by azeotropic distillation.

For the preparation of the polyesters having 2 hydroxyl groups, the organic polycarboxylic acids and/or derivatives thereof and diols are preferably subjected to polycondensation in a molar ratio of dicarboxylic acid to diol of from 1:1.01 to 1:1.8, preferably from 1:1.05 to 1:1.2.

The dicarboxylic acids used may be generally known aliphatic dicarboxylic acids, such as succinic acid, glutaric acid, adipic acid, suberic acid, azelaic acid and sebacic acid, and/or aromatic dicarboxylic acids, such as phthalic acid, isophthalic acid and terephthalic acid. The dicarboxylic acids may be used individually or as mixtures. For the preparation of the polyesterpolyols, it may be advantageous, instead of the carboxylic acid, to use the corresponding carboxylic acid derivatives, such as carboxylates having 1 to 4 carbon atoms in the alcohol radical, carboxylic anhydrides or acyl chlorides. Adipic acid is particularly preferably used for the condensation with the novel diol mixture.

The novel polyesters having 2 hydroxyl groups preferably have a molecular weight of from 500 to 6 000, especially from 1 000 to 3 000, g/mol. The molecular weight is preferably the number average molecular weight.

The novel process for the preparation of the cellular polyisocyanate polyadducts can preferably be carried out by using the following starting materials in a one- or two-stage process:

(a) isocyanate,

(b) compound reactive toward isocyanates,

(d) water, and, if required,

(e) catalysts,

(f) blowing agents and/or

(g) assistants.

The novel process can be particularly preferably carried out in such a way that, in a two-stage process, a prepolymer having isocyanate groups is prepared in the first stage by reacting (a) with (b) and, if required, the chain extenders and/or crosslinking agents (c) described later on and this prepolymer is reacted in the second stage in a mold with a crosslinker component containing (d), it being possible for (e) and, if required, (f) and/or (g) to be contained in the prepolymer and/or the crosslinker component. The crosslinker component may contain a carbodiimide as (g).

The preparation of the novel cellular polyisocyanate polyadducts is preferably carried out in a mold at a surface temperature of the mold inner wall of from 75 to 90° C. The term surface temperature of the mold inner wall is to be understood as meaning the temperature of the surface of the inner wall of the mold, i.e. the surface of the mold, which is usually in contact with the reaction system during the production of the shaped articles, at least briefly, preferably for at least 10 minutes, during the production of the shaped articles.

The novel cellular polyisocyanate polyadducts preferably have a glass transition temperature of less than −33° C., a tensile strength, according to DIN 53571, of ≧3.5, preferably ≧4, N/mm², an elongation, according to DIN 53571, of ≧300%, preferably ≧350%, and a tear propagation strength, according to DIN 53515, of ≧13 N/mm and particularly preferably a compression set (at 80° C.), based on DIN 53572, of less than 25%.

The novel cellular polyisocyanate polyadducts, also referred to below as moldings, are used as damping elements in vehicle construction, for example in automotive construction, for example as auxiliary springs, stop buffers, transverse link bearings, rear axle subframe bearings, stabilizer bearings, longitudinal strut bearings, support bearings for shock-absorbing legs, shock absorber bearings and bearings for wishbones and/or as an emergency wheel which is present on the rim and ensures that the vehicle drives and remains steerable on the cellular polyisocyanate polyadduct in the event of tire damage.

The novel moldings, i.e. the cellular polyisocyanate polyadducts, preferably the microcellular polyurethane elastomers, accordingly not only have excellent mechanical and dynamic properties but in particular the hydrolysis stability and the low-temperature flexibility could be substantially improved as desired according to the invention. In particular, this combination of especially advantageous properties is not known from the prior art.

The production of the shaped articles is preferably carried out at an NCO/OH ratio of from 0.85 to 1.20, the heated starting components being mixed and being introduced into a heated, preferably tightly closing mold in an amount corresponding to the desired density of the shaped articles.

The shaped articles have usually cured after from 10 to 40 minutes and can thus be removed from the mold.

The amount of the reaction mixture introduced into the mold is usually such that the moldings obtained have the density stated above. The cellular polyisocyanate polyadducts obtainable according to the invention preferably have a density, according to DIN 53420, of from 200 to 750, particularly preferably from 300 to 600, kg/m³.

The starting components are usually introduced into the mold at from 15 to 120° C., preferably from 30 to 110° C. The degrees of densification for the production of the moldings are from 1.1 to 8, preferably from 2 to 6.

The novel cellular polyisocyanate polyadducts are expediently prepared by the one-shot process with the aid of the low pressure technique or, in particular, of the known reaction injection molding (RIM) technique in open or, preferably, closed molds. The reaction is carried out in particular with densification in a closed mold.

With the use of a mixing chamber having a plurality of feed nozzles, the starting components can be fed in individually and thoroughly mixed in the mixing chamber. It has proven advantageous to employ the two-component process.

According to a particularly advantageous embodiment, an NCO-containing prepolymer is first prepared in a two-stage process. For this purpose, the components (b) and, if required, (c) are reacted with (a) in excess, usually at from 80 to 160° C., preferably from 110 to 150° C. The reaction time is such that the theoretical NCO content is achieved.

Accordingly, the novel production of the moldings is preferably effected in a two-stage process by preparing a prepolymer having isocyanate groups in the first stage by reacting (a) with (b) and, if required, (c) and reacting this prepolymer in the second stage in a mold with a crosslinker component containing (d), (e) and, if required, (f) and/or (g) being contained in the prepolymer and/or the crosslinker component.

The assistants and/or additives (g) may preferably be present in the crosslinker component. As assistants and additives (g) in the crosslinker component, at least one generally known carbodiimide is preferably used as a hydrolysis stabilizer, for example 2,2′,6,6′-tetraisopropyldiphenylcarbodiimide.

For improving the demolding of the moldings produced according to the invention, it has proved advantageous to coat the inner surfaces of the mold, at least at the beginning of a production series, with conventional external lubricants, for example those based on wax or on silicone, or in particular with aqueous soap solutions.

The molding times are on average from 10 to 40 minutes, depending on the size and geometry of the shaped article.

After the production of the shaped articles in the mold, said articles can preferably be heated for from 1 to 48 hours at, usually, from 70 to 140° C.

Regarding the starting components contained in the novel reaction mixture, the following may be stated:

The isocyanates (a) used may be generally known (cyclo)aliphatic and/or aromatic polyisocyanates. Aromatic diisocyanates, preferably diphenylmethane 2,2′-, 2,4′- and/or 4,4′-diisocyanate (MDI), naphthylene 1,5-diisocyanate (NDI), tolylene 2,4- and/or 2,6-diisocyanate (TDI), dimethylbiphenyl 3,3′-diisocyanate, diphenylethane 1,2-diisocyanate and p-phenylene diisocyanate, and/or (cyclo)aliphatic isocyanates, e.g. hexamethylene 1,6-diisocyanate and 1-isocyanato-3,3,5-trimethyl-5-isocyanatomethylcyclohexane, and/or polyisocyanates, e.g. polyphenylpolymethylene polyisocyanates, are particularly suitable for the production of the novel composite elements. The isocyanates can be used in the form of pure compounds, as mixtures and/or in modified form, for example in the form of uretdiones, isocyanurates, allophanates or biurets, preferably in the form of reaction products containing urethane and isocyanate groups, i.e. isocyanate prepolymers. Unmodified or modified diphenylmethane 2,2′-, 2,4′- and/or 4,4′-diisocyanate (MDI), naphthylene 1,5-diisocyanate (NDI), tolylene 2,4- or 2,6-diisocyanate (TDI) and/or dimethylbiphenyl 3,3′-diisocyanate and/or mixtures of these isocyanates are preferably used.

The novel polyesters described above are used as compounds (b) reactive toward isocyanates. These can, if required, be used together with generally known polyhydroxy compounds, preferably those having a functionality, with respect to isocyanate groups, of from 2 to 3 and preferably a molecular weight of from 60 to 6 000, particularly preferably from 500 to 6 000, in particular from 800 to 3 500. If required, generally known polyetherpolyols, polyesterpolyols, polyetheresterpolyols and/or hydroxyl-containing polycarbonates are preferably used in addition to the novel polyesterpolyol as (b). Particularly preferably, exclusively the novel polyesters are used as component (b).

The following statements relate to the polyhydroxy compounds (b), which, if required, can be used in addition to the novel polyesters:

Suitable polyesterpolyols can be prepared, for example, from dicarboxylic acids of 2 to 12 carbon atoms and dihydric alcohols. Examples of suitable dicarboxylic acids are adipic acid, phthalic acid and maleic acid. Examples of dihydric alcohols are glycols of 2 to 16, preferably 2 to 6, carbon atoms, e.g. ethylene glycol, diethylene glycol, 1,4-butanediol, 1,5-pentanediol, 1,6-hexanediol, 1,10-decanediol, 1,3-propanediol and dipropylene glycol. Depending on the desired properties, the dihydric alcohols can be used alone or, if required, as mixtures with one another.

Preferably used polyesterpolyols are ethanediol polyadipates, 1,4-butanediol polyadipates, ethanediol butanediol polyadipates, 1,6-hexanediol neopentylglycol polyadipates, 1,6-hexanediol 1,4-butanediol polyadipates and/or polycaprolactones.

Suitable ester-containing polyoxyalkylene glycols, essentially polyoxytetramethylene glycols, are polycondensates of organic, preferably aliphatic dicarboxylic acids, in particular adipic acid, with polyoxymethylene glycols having a number average molecular weight of from 162 to 600 and, if required, aliphatic diols, in particular 1,4-butanediol. Other suitable ester-containing polyoxytetramethylene glycols are those polycondensates formed from the polycondensation of ε-caprolactone.

Suitable carbonate-containing polyoxyalkylene glycols, essentially polyoxytetramethylene glycols, are polycondensates of these with alkyl or aryl carbonates or phosgene.

Exemplary embodiments of the component (b) are stated in DE-A 195 48 771, page 6, lines 26 to 59.

In addition to the components described above and reactive toward isocyanates, chain extenders and/or crosslinking agents (c) having a molecular weight of less than 500, preferably from 60 to 499, may also be used, for example those selected from the group consisting of the di- and/or trifunctional alcohols, di- to tetrafunctional polyoxyalkylenepolyols and the alkyl-substituted aromatic diamines or of mixtures of at least two of said chain extenders and/or crosslinking agents.

For example, alkanediols of 2 to 12, preferably 2, 4 or 6, carbon atoms may be used as (c), for example ethanediol, 1,3-propanediol, 1,5-pentanediol, 1,6-hexanediol, 1,7-heptanediol, 1,8-octanediol, 1,9-nonanediol, 1,10-decanediol and preferably 1,4-butanediol, dialkylene glycols of 4 to 8 carbon atoms, e.g. diethylene glycol and dipropylene glycol, and/or di- to tetrafunctional polyoxyalkylenepolyols.

However, branched and/or unsaturated alkanediols having, usually, not more than 12 carbon atoms are also suitable, for example 1,2-propanediol, 2-methyl-1,3-propanediol, 2,2-dimethyl-1,3-propanediol, 2-butyl-2-ethyl-1,3-propanediol, but-2-ene-1,4-diol and but-2-yne-1,4-diol, diesters of terephthalic acid with glycols of 2 to 4 carbon atoms, e.g. ethylene glycol or 1,4-butanediol bis(terephthalate), hydroxyalkylene ethers of hydroquinone or of resorcinol, e.g. 1,4-di(β-hydroxyethyl)hydroquinone or 1,3-di(β-hydroxyethyl)resorcinol, alkanolamines of 2 to 12 carbon atoms, e.g. ethanolamine, 2-aminopropanol and 3-amino-2,2-dimethylpropanol, N-alkyldialkanolamines, e.g. N-methyl- and N-ethyldiethanolamine.

Examples of crosslinking agents (c) having a higher functionality are trifunctional alcohols and alcohols having a higher functionality, e.g. glycerol, trimethylolpropane, pentaerythritol and trihydroxycyclohexanes, and trialkanolamines, e.g. triethanolamine.

Alkyl-substituted aromatic polyamines having a molecular weight of, preferably, from 122 to 400, in particular primary aromatic diamines which have, ortho to the amino groups, at least one alkyl substituent which reduces the reactivity of the amino group by steric hindrance, which are liquid at room temperature and are at least partly but preferably completely miscible with the higher molecular weight, preferably at least difunctional compounds (b) under the processing conditions, have proven excellent chain extenders and are therefore preferably used.

For the production of the novel moldings, the industrially readily obtainable 1,3,5-triethyl-2,4-phenylenediamine, 1-methyl-3,5-diethyl-2,4-phenylenediamine, mixtures of 1-methyl-3,5-diethyl-2,4- and -2,6-phenylenediamines, i.e. DETDA, isomer mixtures of 3,3′-dialkyl- or 3,3′,5,5′-tetraalkyl-substituted 4,4′-diaminodiphenylmethanes having 1 to 4 carbon atoms in the alkyl radical, in particular 3,3′,5,5′-tetraalkyl-substituted 4,4′-diaminodiphenylmethanes containing bonded methyl, ethyl and isopropyl radicals and mixtures of said tetraalkyl-substituted 4,4′-diaminodiphenylmethanes and DETDA can be used.

In order to achieve specific mechanical properties, it may also be expedient to use the alkyl-substituted aromatic polyamines as a mixture with the abovementioned low molecular weight polyhydric alcohols, preferably dihydric and/or trihydric alcohols or dialkylene glycols.

According to the invention, the preparation of the cellular polyisocyanate polyadducts is preferably carried out in the presence of water (d). The water acts both as a crosslinking agent with formation of urea groups and, owing to the reaction with isocyanate groups with formation of carbon dioxide, as a blowing agent. Owing to this dual function, it is mentioned in this document separately from (c) and (f). By definition, the components (c) and (f) thus contain no water which by definition is mentioned exclusively as (d).

The amounts of water which can expediently be used are from 0.01 to 5, preferably from 0.3 to 3.0, % by weight, based on the weight of the component (b).

In order to accelerate the reaction, generally known catalysts (e) may be added to the reaction batch both in the preparation of a prepolymer and, if required, in the reaction of a prepolymer with a crosslinker component. The catalysts (e) may be added individually or as a mixture with one another. They are preferably organometallic compounds, such as tin(II) salts of organic carboxylic acids, e.g. tin(II) dioctanoate, tin(II) dilaurate, dibutyltin diacetate and dibutyltin dilaurate, and tertiary amines, such as tetramethylethylenediamine, N-methylmorpholine, diethylbenzylamine, triethylamine, dimethylcyclohexylamine, diazabicyclooctane, N,N′-dimethylpiperazine, N-methyl-N′-(4-N-dimethylamino)butylpiperazine, N,N,N′,N″,N″-pentamethyldiethylenediamine or the like.

Other suitable catalysts are amidines, e.g. 2,3-dimethyl-3,4,5,6-tetrahydropyrimidine, tris(dialkylaminoalkyl)-s-hexahydrotriazines, in particular tris(N,N-dimethylaminopropyl)-s-hexahydrotriazine, tetraalkylammonium hydroxides, e.g. tetramethylammonium hydroxide, alkali metal hydroxides, e.g. sodium hydroxide, and alkali metal alcoholates, e.g. sodium methylate and potassium isopropylate, and alkali metal salts of long-chain fatty acids having 10 to 20 carbon atoms and, if required, OH side groups.

Depending on the reactivity to be established, the catalysts (e) are used in amounts of from 0.001 to 0.5% by weight, based on the prepolymer.

If required, conventional blowing agents (f) may be used in the polyurethane preparation. For example, low-boiling liquids which vaporize under the influence of the exothermic polyaddition reactions are suitable. Liquids which are inert to the organic polyisocyanate and have boiling points below 100° C. are suitable. Examples of such preferably used liquids are halogenated, preferably fluorinated, hydrocarbons, e.g. methylene chloride and dichloromonofluoromethane, perfluorinated or partially fluorinated hydrocarbons, e.g. trifluoromethane, difluoromethane, difluoroethane, tetrafluoroethane and heptafluoropropane, hydrocarbons, e.g. n-butane, isobutane, n-pentane and isopentane and the industrial mixtures of these hydrocarbons, propane, propylene, hexane, heptane, cyclobutane, cyclopentane and cyclohexane, dialkyl ethers, e.g. dimethyl ether, diethyl ether and furan, carboxylic esters, e.g. methyl and ethyl formate, ketones, e.g. acetone, and/or fluorinated and/or perfluorinated, tertiary alkylamines, e.g. perfluorodimethylisopropylamine. Mixtures of these low-boiling liquids with one another and/or with other substituted or unsubstituted hydrocarbons may also be used.

The most expedient amount of low-boiling liquid for the preparation of such cellular resilient moldings from elastomers containing bonded urea groups depends on the density which it is intended to achieve and on the amount of water preferably concomitantly used. In general, amounts of from 1 to 15, preferably from 2 to 11, % by weight, based on the weight of the component (b), give satisfactory results. Particularly preferably, exclusively water (d) is used as the blowing agent.

In the novel production of the shaped articles, assistants (g) may be used. These include, for example, generally known surfactants, foam stabilizers, cell regulators, fillers, flameproofing agents, nucleating agents, antioxidants, stabilizers, microbicides lubricants and mold release agents, dyes and pigments.

Examples of suitable surfactants are compounds which serve for supporting the homogenization of the starting materials and may also be suitable for regulating the cell structure. Examples are emulsifiers, such as the sodium salts of castor oil sulfates and of fatty acids and salts of fatty acids with amines, for example of oleic acid with diethylamine, of stearic acid with diethanolamine and of ricinoleic acid with diethanolamine, salts of sulfonic acids, for example alkali metal or ammonium salts of dodecylbenzene- or dinaphthylmethanedisulfonic acid and ricinoleic acid; foam stabilizers, such as siloxane/oxyalkylene copolymers and other organosiloxanes, oxyethylated alkylphenols, oxyethylated fatty alcohols, liquid paraffins, castor oil esters or ricinoleic esters, Turkey red oil and peanut oil and cell regulators, such as paraffins, fatty alcohols and dimethylpolysiloxanes. Furthermore, oligomeric polyacrylates having polyoxyalkylene and fluoroalkane radicals as side groups are suitable for improving the emulsifying effect, the cell structure and/or the stabilization thereof. The surfactants are usually used in amounts of from 0.01 to 5 parts by weight, based on 100 parts by weight of the higher molecular weight polyhydroxy compounds (b).

Fillers, in particular reinforcing fillers, are to be understood as meaning the conventional organic and inorganic fillers, reinforcing agents and weighting agents known per se. Specific examples are inorganic fillers, such as silicate minerals, for example sheet silicates, such as antigorite, serpentine, hornblends, amphiboles, chrysotile and talc; metal oxides, such as kaolin, aluminas, aluminum silicate, titanium oxides and iron oxides, metal salts, such as chalk, barite and inorganic pigments, such as cadmium sulfide and zinc sulfide, and glass particles. Examples of suitable organic fillers are carbon black, melamine, expanded graphite, rosin, cyclopentadienyl resins and graft polymers.

Preferably used reinforcing fillers are fibers, for example carbon fibers, glass fibers, particularly when high heat distortion resistance or very high rigidity is required, it being possible for the fibers to be treated with adhesion promoters and/or sizes.

The inorganic and organic fillers can be used individually or as mixtures and are incorporated into the reaction mixture usually in amounts of from 0.5 to 50, preferably from 1 to 30, % by weight, based on the weight of the components (a) to (c).

Suitable flameproofing agents are, for example, tricresyl phosphate, tris(2-chloroethyl) phosphate, tris(2-chloropropyl) phosphate, tris(1,3-dichloropropyl) phosphate, tris(2,3-dibromopropyl) phosphate and tetrakis(2-chloroethyl) ethylene diphosphate.

In addition to the abovementioned halogen-substituted phosphates, inorganic flameproofing agents, such as red phosphorus, hydrated alumina, antimony trioxide, arsenic trioxide, ammonium polyphosphate and calcium sulfate, or cyanuric acid derivatives, e.g. melamine, or mixtures of at least two flameproofing agents, e.g. ammonium phosphates and melamine, and, if required, starch and/or expanded graphite can also be used for flameproofing the cellular PU elastomers prepared according to the invention. In general, it has proven expedient to use from 5 to 50, preferably from 5 to 25, parts by weight of said flameproofing agents or mixtures thereof per 100 parts by weight of the components (a) to (c).

Nucleating agents which may be used are, for example, talc, calcium fluoride, sodium phenylphosphinate, alumina and finely divided polytetrafluoroethylene in amounts of up to 5% by weight, based on the total weight of the components (a) to (c).

Suitable antioxidants and heat stabilizers which may be added to the novel cellular PU elastomers are, for example, halides of metals of group I of the Periodic Table of the Elements, for example sodium, potassium and lithium halides, if necessary in combination with copper(I) halides, for example chlorides, bromides or iodides, sterically hindered phenols, hydroquinones and substituted compounds of these groups and mixtures thereof, which are preferably used in concentrations of up to 1% by weight, based on the weight of the components (a) to (c).

Examples of hydrolysis stabilizers are various substituted carbodiimides, such as 2,2′,6,6′-tetraisopropyldiphenylcarbodiimide or carbodiimides based on 1,3-bis(1-methyl-1-isocyanatoethyl)benzene as are described for example in DE-A 19821668, DE-A 19821666, DE-A 10004328, DE-A 19954500, DE-A 19809634 or DE-A 4318979, which are used in general in amounts of up to 2.0% by weight, based on the weight of the components (a) to (c).

Lubricants and demolding agents, which as a rule are likewise added in amounts of up to 1% by weight, based on the weight of the components (a) to (c), are stearic acid, stearyl alcohol, stearic esters and stearamides and the fatty esters of pentaerythritol.

Furthermore, organic dyes, such as nigrosine, and pigments, e.g. titanium dioxide, cadmium sulfide, cadmium sulfide selenide, phthalocyanines, ultramarine blue or carbon black, may be added.

Further information on the abovementioned other conventional assistants and additives appear in the technical literature.

The examples which follow illustrate the invention.

### COMPARATIVE EXAMPLE I

a) Preparation of a Prepolymer having Isocyanate Groups and Based on 1,5-NDI

1 000 parts by weight (0.5 mol) of a poly(ethanediol adipate) having an average molecular weight of 2 000 (calculated from the experimentally determined hydroxyl number) were heated to 140° C. and mixed at this temperature with 240 parts by weight (1.14 mol) of solid 1,5-NDI with thorough stirring and reacted.

A prepolymer having an NCO content of 4.14% by weight and a viscosity at 90° C. of 2 300 mPa·s (measured using a rotational viscometer from Rheometrics Scientific, with which the viscosities of the following comparative examples and examples were also measured) was obtained.

b) Production of Cellular Moldings

Crosslinker component which consisted of

| | |
|---|---|
| 55 | parts by weight of a 50% strength aqueous solution of a |
| | fatty acid sulfonate, |
| 27.5 | parts by weight of water, |
| 31.5 | parts by weight of |
| | 2,2′,6,6′-tetraisopropyldiphenylcarbodiimide, |
| 30.5 | parts by weight of a fatty acid polyglycol ester, |
| 7.0 | parts by weight of a mixture of fatty acid polyglycol |
| | esters and amine salts of alkylbenzenesulfonates |
| | and |
| 0.7 | part by weight of a mixture of |
| | 30% by weight of pentamnethyldiethylenetriamine and |
| | 70% by weight of N-methyl-N′-(dimethylaminoethyl)- |
| | piperazine |

100 parts by weight of the prepolymer containing isocyanate groups and heated to 90° C. were thoroughly stirred for about 10 seconds with 2.29 parts by weight of the crosslinker component heated to 50° C. The reaction mixture was then introduced into a closable, metallic mold heated to 80° C., the mold was closed and the reaction mixture was allowed to cure. After 30 minutes, the microcellular molding was removed from the mold and was heated at 110° C. for 16 hours for thermal postcuring.

### COMPARATIVE EXAMPLE II

a) Preparation of a Prepolymer having Isocyanate Groups and Based on 1,5-NDI and 4,4′-MDI

1 000 parts by weight (0.5 mol) of a poly(ethanediol-(0.5 mol)-butane-1,4-diol-(0.5 mol) adipate (1 mol)) having an average molecular weight of 2 000 (calculated from the experimentally determined hydroxyl number) were heated to 140° C. and mixed at this temperature with 285 parts by weight (1.14 mol) of 4,4′-MDI and 80 parts by weight (0.38 mol) of NDI with thorough stirring and were reacted.

A prepolymer having an NCO content of 6.25% and a viscosity, at 90° C., of 1 900 mpa·s was obtained.

b) Production of Cellular Moldings

Crosslinker component which consisted of

| | |
|---|---|
| 87.5 | parts by weight of a 50% strength aqueous solution of a |
| | fatty acid sulfonate, |
| 25 | parts by weight of |
| | 2,2′,6,6′-tetraisopropyldiphenylcarbodiimide, |
| 8.0 | parts by weight of a mixture of fatty acid polyglycol |
| | esters and amine salts of alkylbenzenesulfonates |
| | and |
| 0.4 | part by weight of a mixture of |
| | 30% by weight of pentamethyldiethylenetriamine and |
| | 70% by weight of |
| | N-methyl-N′-(dimethylaminoethyl)piperazine |

100 parts by weight of the prepolymer containing isocyanate groups and heated to 90° C. were thoroughly stirred for about 10 seconds with 3.45 parts by weight of the crosslinker component heated to 50° C. The reaction mixture was then introduced into a closable, metallic mold heated to 80° C., the mold was closed and the reaction mixture was allowed to cure. After 30 minutes, the microcellular molding was removed from the mold and was heated at 110° C. for 16 hours for thermal postcuring.

### EXAMPLE 1 (ACCORDING TO THE INVENTION)

a) Preparation of a Prepolymer having Isocyanate Groups and Based on 1,5-NDI

1 000 parts by weight (0.5 mol) of a poly(2-methyl-1,3-propanediol-(0.5 mol)-butane-1,4-diol-(0.5 mol) adipate (1 mol)) having an average molecular weight of 2 000 (calculated from the experimentally determined hydroxyl number) were heated to 140° C. and mixed at this temperature with 240 parts by weight (1.14 mol) of solid 1,5-NDI with thorough stirring and were reacted.

A prepolymer having an NCO content of 4.05% by weight and a viscosity, at 90° C., of 4 630 mPa·s was obtained.

b) Production of Cellular Moldings

The cellular moldings were produced using the prepolymer according to example 1a, analogously to the information in comparative example Ib.

### EXAMPLE 2 (ACCORDING TO THE INVENTION)

a) Preparation of a Prepolymer having Isocyanate Groups and Based on 1,5-NDI and 4,4′-MDI

1 000 parts by weight (0.5 mol) of a poly(2-methyl-1,3-propanediol-(0.5 mol)-butane-1,4-diol-(0.5 mol) adipate (1 mol)) having an average molecular weight of 2 000 (calculated from the experimentally determined hydroxyl number) were heated to 140° C. and mixed at this temperature with 285 parts by weight (1.14 mol) of 4,4′-MDI and 80 parts by weight (0.38 mol) of NDI with thorough stirring and were reacted.

A prepolymer having an NCO content of 6.11% and a viscosity, at 90° C., of 2 900 mPa·s was obtained.

b) Production of Cellular Moldings

The cellular moldings were produced using the prepolymer according to example 2a, analogously to the information in comparative example IIb.

The mechanical and dynamic properties of the moldings were tested under the conditions described below.

Test Conditions

The glass transition temperature was determined according to ISO 6721-1 and ISO 6721-7 on S3A tensile test bars from the finished article with the aid of a torsional vibration tester according to the principle of forced vibration. The glass transition temperature was determined at the maximum of the loss modulus. The samples were cooled to −80° C., kept at this temperature for minutes and then heated to 40° C. at a heating rate of 2 K/min. The measuring frequency was 1 Hz. The static mechanical properties (the density of the test specimens was in each case 0.5 g/cm³) were measured on the basis of the tensile strength according to DIN 53 571, the elongation at break according to DIN 53 571, the tear propagation strength according to DIN 53 515 and the compression set at 80° C. according to a modification of DIN 53 572 using 18 mm high spacers and test specimens having a base area of 40×40 mm and a height of 30±1 mm. The compression set (CS) was calculated according to the equation

CS=[(H₀−H₂)/(H₀−H₁))]*100[%]

where

H₀ is the original height of the test specimen in mm,

H₁ is the height of the test specimen in the deformed state in mm,

H₂ is the height of the test specimen after relaxation in mm.

The dynamic mechanical properties of the test specimens were determined on the basis of the increase in travel (IT) under the action of maximum force and the set (S). The test specimens consisted of a cylindrical test spring having a height of 100 mm, an external diameter of 50 mm and an internal diameter of 10 mm. The test specimens were subjected to 100 000 load changes with a force of 6 kN and a frequency of 1.2 Hz. The determination of the height HR for determining the set after the dynamic test was carried out after the spring characteristic had been recorded: H₀ is the initial height. The molding was precompressed three times with maximum force. Then, in the 4th cycle, the characteristic was recorded. The compression rate was 50 mm/min. After 10 minutes, H₁ was determined, i.e. that of the component after recording of the characteristic. Only thereafter was the dynamic test started. The characteristics at −30° C. were recorded analogously but in a conditioned chamber thermostatted at −30° C. After the dynamic mechanical testing of the test specimens, the set was determined according to the following equation:

S=[(H₀−H_{R})/H₀)]*100[%]

where

H₀ is the original height of the test specimen in mm and

H_{R} is the residual height of the test specimen after the dynamic test, measured after storage for 24 hours at 23° C. and 50% relative humidity.

The set is a measure of the permanent deformation of the cellular PU elastomer during the fatigue test. The lower this value, the higher is the dynamic efficiency of the material. The dynamic tests were carried out without additional cooling in a conditioned room at 23° C. and 50% relative humidity.

The mechanical properties determined for the test specimens are summarized in the table below and in FIG. 1, which shows the low-temperature characteristics at −30° C.

| Example/Comparative example | I | II | 1 | 2 |
|---|---|---|---|---|
| NCO content [%] | 4.14 | 6.25 | 4.05 | 6.11 |
| Viscosity 90° C. [mPa · s] | 2 300 | 1 900 | 4 630 | 2 900 |
| Static mechanical properties | | | | |
| Compression set 80° C. [%] | 14.6 | 17.0 | 13.6 | 12.9 |
| Tensile strength [N/mm²] | 5.8 | 5.6 | 4.6 | 4.6 |
| Elongation [%] | 410 | 500 | 400 | 410 |
| Tear propagation strength [N/mm] | 20.3 | 19.9 | 17.7 | 13.7 |
| Hydrolysis stability | | | | |
| Days to end | 14 | 21 | 30 | 27 |
| Tensile strength at end [N/mm²] | 0.6 | 0.3 | 1.3 | 0.4 |
| Elongation at end [%] | 43 | 66 | 78 | 119 |
| Low-temperature flexibility | | | | |
| Glass transition temperature, | −29 | −24 | −37 | −34 |
| shear modulus [° C.] | | | | |
| Low-temperature characteristic (−30° C.) | | | | |
| (see graphs) | | | | |
| Force 2 kN [mm] | 36.1 | 6.3 | 53.1 | 29.4 |
| Force 6 kN [mm] | 60.2 | 34.8 | 67.5 | 61.6 |
| Dynamic mechanical properties | | | | |
| Set [%] | 6-7 | 8-11 | 5-7 | 8-11 |
| Increase in travel [mm] | 1.5-2.0 | 2.5-3.5 | 1.2-1.8 | 2.5-3.5 |

We claim:

1. A process for the preparation of cellular polyisocyanate polyadducts by reacting (a) isocyanates with (b) compounds reactive toward isocyanates and (d) water, wherein a polyester having 2 hydroxyl groups and based on the condensation of at least one dicarboxylic acid with 2-methylpropane-1,3-diol, is used as (b).

2. A process as claimed in claim 1, wherein the following starting materials are used in a one- or two-stage process:
(a) isocyanate,
(b) compound reactive toward isocyanates,
(d) water,
and, if required,
(e) catalysts,
(f) blowing agents and/or
(g) assistants.

3. A process as claimed in claim 2, wherein, in a two-stage process, a prepolymer having isocyanate groups is prepared in the first stage by reacting (a) with (b) and this prepolymer is reacted in the second stage in a mold with a crosslinker component containing (d).

4. A process as claimed in claim 3, wherein the crosslinker component contains carbodiimide as (g).

5. A process as claimed in claim 1, wherein the preparation is carried out in a mold at a surface temperature of the mold inner wall of from 75 to 90° C.

6. A process as claimed in claim 1, wherein the cellular polyisocyanate polyadducts have a density, according to DIN 53420, of from 200 to 750 kg/m³.

7. A process as claimed in claim 1, wherein the cellular polyisocyanate polyadducts have a glass transition temperature of less than −33° C., a tensile strength, according to DIN 53571, of ≧3.5 N/mm², an elongation, according to DIN 53571, of ≧300% and a tear propagation strength, according to DIN 53515, of ≧13 N/mm.

8. A cellular polyisocyanate polyadduct obtainable by a process as claimed in any of claims 1 to 7.

9. A cellular polyisocyanate polyadduct having a density, according to DIN 53420, of from 200 to 750 kg/M³, a glass transition temperature of less than −33° C., a tensile strength, according to DIN 53571, of ≧3.5 N/mm², an elongation, according to DIN 53571, of ≧300% and a tear propagation strength, according to DIN 53515, of ≧13 N/mm and obtainable by a process as claimed in any of claims 1 to 7.
